(19) United States
(12) Patent Application Publication
(10) Pub. No.: US 2007/0019802 A1
(43) Pub. Date: Jan. 25, 2007

(54) Audio data stream synchronization

(75) Inventors: Charles Ubriaco, Northport, NY (US); David Tietjen Lundquist, Setauket, NY (US); Patrick M. Brown, Holbrook, NY (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Symbol Technologies, Inc., Holtsville, NY (US)

(21) Appl. No.: 11/171,788

(22) Filed: Jun. 30, 2005

(51) Int. Cl. H04M 9/08

(52) U.S. Cl. 379/406.01

(57) ABSTRACT

Systems and methods of synchronizing an input signal and an output signal via employing a sampling component that samples a speaker output and a microphone input during a full duplex communication, at a same clock frequency and same exact time to supply time synchronized sample signal(s). A software acoustic echo canceller (AEC) can then provide for production of a reconditioned microphone signal, wherein the speaker signal is absent therefrom. The time synchronized samples can be processed by the software AEC, in general without real time constraints that can be imposed by the operating system (OS).

### BACKGROUND OF THE INVENTION

Acoustic echo is a common problem with full duplex audio systems, for example, audio conferencing systems and/or speech recognition systems. Acoustic echo originates in a local audio loop back that occurs when an input transducer, such as a microphone, picks up audio signals from an audio output transducer, for example, a speaker, and sends it back to an originating participant. The originating participant will then hear the echo of the participant's own voice as the participant speaks. Depending on the delay, the echo may continue to be heard for some time after the originating participant has stopped speaking.

For example, a scenario can be considered wherein a first participant at a first physical location with a microphone and speaker and a second participant at a second physical location with a microphone and speaker are taking part in a call or conference. When the first participant speaks into the microphone at the first physical location, the second participant hears the first participant's voice played on speaker(s) at the second physical location. However, the microphone at the second physical location then picks up and transmits the first participant's voice back to the first participant's speakers. The first participant will then hear an echo of the first participant's own voice with a delay due to the round-trip transmission time. The delay before the first participant starts hearing the echo of the first participant's own voice, as well as how long the first participant continues to hear the first participant's own echo after the first participant has finished speaking depends on the time it takes to transmit the first participant's voice to the second participant, how much reverberation occurs in the second participant's room, and how long it takes to send the first participant's voice back to the first participant's speakers. Such delay may be several seconds when the Internet is used for international voice conferencing.

Acoustic echo can be caused or exacerbated when sensitive microphone(s) are used, as well as when the microphone and/or speaker gain (volume) is turned up to a high level, and also when the microphone and speaker(s) are positioned so that the microphone is close to one or more of the speakers. In addition to being annoying, acoustic echo can prevent normal conversation among participants in a conference. In full duplex systems without acoustic echo cancellation, it is possible for the system to get into a feedback loop which makes so much noise the system is unusable.

Conventionally, acoustic echo is reduced using audio headset(s) that prevent an audio input transducer (e.g., microphone) from picking up the audio output signal. Additionally, special microphones with echo suppression features can be utilized. However, these microphones are typically expensive as they may contain digital signal processing electronics that scan the incoming audio signal and detect and cancel acoustic echo. Some microphones are designed to be very directional, which can also help reduce acoustic echo.

Acoustic echo can also be reduced through the use of a digital acoustic echo cancellation (AEC) component. This AEC component can remove the echo from a signal while minimizing audible distortion of that signal. This AEC component must have access to digital samples of the audio input and output signals. These components process the input and output samples in the digital domain in such a way as to reduce the echo in the input or capture samples to a level that is normally inaudible.

An analog waveform is converted to digital samples through a process known as analog to digital (A/D) conversion. Devices that perform this conversion are known as analog to digital converters, or A/D converters. Digital samples are converted to an analog waveform through a process known as digital to analog (D/A) conversion. Devices that perform this conversion are known as digital to analog converters, or D/A converters. Most A/D and D/A conversions are performed at a constant sampling rate.

Acoustic echo cancellation components work by subtracting a filtered version of the audio samples sent to the output device from the audio samples received from the input device. This processing assumes that the output and input sampling rates are exactly the same. Because there are a wide variety of input and output devices available for PC devices, it is important that AEC work even when the input and output devices are not the same.

The digital signals are provided to the processor, and can be synchronous between the input signal and the output signal paths, yet such is not guaranteed to be the case. To perform acoustic echo cancellation the time relationship between the input audio stream and the output audio stream must typically be known. Such can be readily determined for a hardware solution. Nonetheless for a software acoustic echo canceller this relationship can be difficult to determine. For example, complications can arise from the system latency and the variable latency in processing the input and output audio streams.

Therefore, there is a need to overcome the aforementioned deficiencies associated with conventional devices.

### SUMMARY

The following presents a simplified summary of the invention in order to provide a basic understanding of one or more aspects of the invention. This summary is not an extensive overview of the invention. It is intended to neither identify key or critical elements of the invention, nor to delineate the scope of the subject invention. Rather, the sole purpose of this summary is to present some concepts of the invention in a simplified form as a prelude to the more detailed description that is presented hereinafter.

The subject invention provides for systems and methods of synchronizing an input signal and an output signal via employing a sampling component that provides sampling for a speaker output and a microphone input during a full duplex communication, and at a same clock frequency and same exact time, to supply time synchronized sample signal(s). Such time synchronized signals can be buffered, and supplied to a software acoustic echo canceller (AEC) for production of a reconditioned microphone signal, wherein the speaker signal is absent therefrom. Accordingly, the time synchronized samples can be processed by the software AEC, in general without real time constraints that can be imposed by the operating system (OS). For example, from an OS point of view high resolution timing constraints can be removed, and adjustments to samples due to time and manner of calling can be mitigated.

In a related aspect, a set of transducers (e.g., microphones, speakers) can interface a coder/decoder processing system (CODEC) that includes a sampling component of the subject invention. Such CODEC converts digital signals to analog signals and vice versa, wherein the sampling component can supply a re-sampling of the speaker output concurrently with the microphone input, to form a time synchronized signal. The CODEC can include a two channel Analog to Digital (A/D) converter, wherein one channel can provide connection to an output of the Digital to Analog (D/A) converter associated with the speaker. Accordingly, the time relationship between the input audio stream and the output audio stream can be readily identified to the acoustic echo cancellation software for an efficient removal of the far end speaker signal.

In accordance with an exemplary methodology, initially an acoustic echo path can convey an audio signal from an output speaker to a CODEC that includes a sampling component of the subject invention. Concurrently, an input signal from microphone can be forwarded to such sampling component. Next, the speaker and microphone data can be sampled at a fixed sample rate (e.g., 8 KHz, or 16 KHz, or the like for full duplex communication). Such sample rate remains fixed for every session, even though it can vary from one session to another session. Subsequently, such time synchronized signals can be buffered, and processed by echo cancellation systems and software at a convenient time. Artificial intelligence schemes can also be employed in conjunction with various aspects of synchronization according to the subject invention.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings. To facilitate the reading of the drawings, some of the drawings may not have been drawn to scale from one figure to another or within a given figure.

### BRIEF DESCRIPTION OF THE DRAWINGS

FIG. 1 illustrates a block diagram of a sampling component that synchronizes a microphone input and a speaker output signal.

FIG. 2 illustrates a sampling component as part of a coder/decoder processing system.

FIG. 3 illustrates an exemplary synchronized signal to be processed by software AEC.

FIG. 4 illustrates a buffer that captures synchronized data in accordance with an exemplary aspect of the subject invention.

FIG. 5 illustrates a particular schematic block diagram of a software AEC system that employs a sampling component.

FIG. 6 illustrates an exemplary methodology of data sampling.

FIG. 7 illustrates an exemplary computer environment that can implement synchronized signals of the subject innovation.

FIG. 8 illustrates a schematic block diagram for a particular host unit that can employ the sampling component of the subject innovation.

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

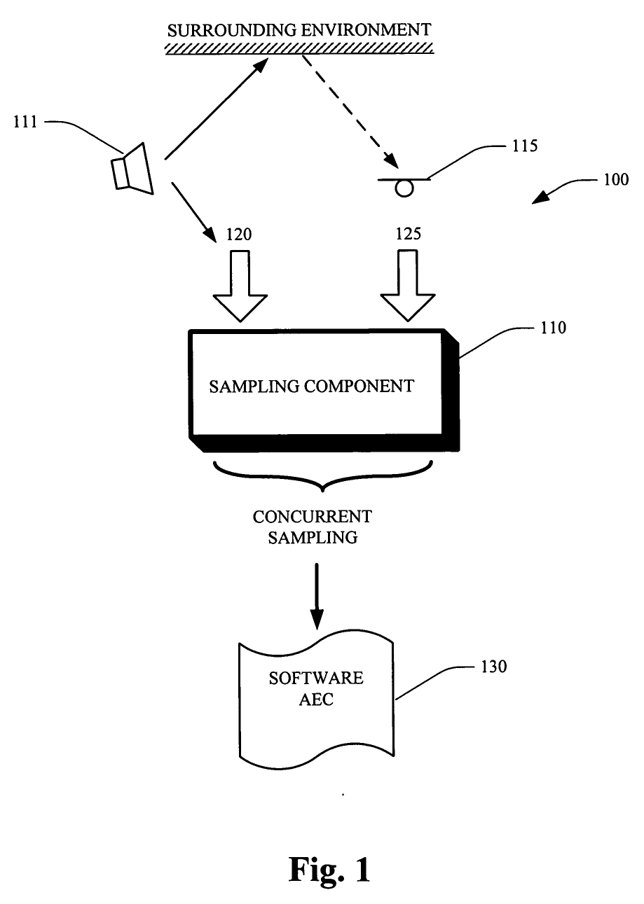

Referring initially to FIG. 1 there is illustrated a sampling component 110 in accordance with an aspect of the subject invention. The sampling component 110 can typically convert continuous signals into discrete values (e.g., digital signals), during a full duplex communication. As illustrated, such sampling component 110 can take a speaker 111 output 120 and a microphone 115 input 125 at a same exact time and at a same clock frequency. In doing so, at the time that the microphone 115 input 125 is being sampled, and concurrently therewith the speaker output is also being (re-)sampled. Such synchronized signals can then be processed by a software acoustic echo canceller (AEC) 130.

The software AEC 130 can mitigate (or eliminate) an echo as part of the captured audio inputs from sound(s) played from a render transducer (e.g., speaker(s)). The echo reduction system of the subject invention can be employed by application(s), such as video conferencing system(s) and/or speech recognition engine(s) to reduce the echo due to acoustic feedback from a render transducer (not shown) to a capture transducer (e.g., microphone) (not shown). The software AEC 130 can further employ an adaptive filter (not shown) to model the impulse response of the room/environment. The echo is either removed (cancelled) or reduced once the adaptive filter converges by subtracting the output of the adaptive filter from the audio input signal by a differential component (not shown). Failed or lost convergence of the adaptive filter may result in the perception of echo or audible distortion by the end user, and a notification component (not shown) can notify applications of such non-convergence.

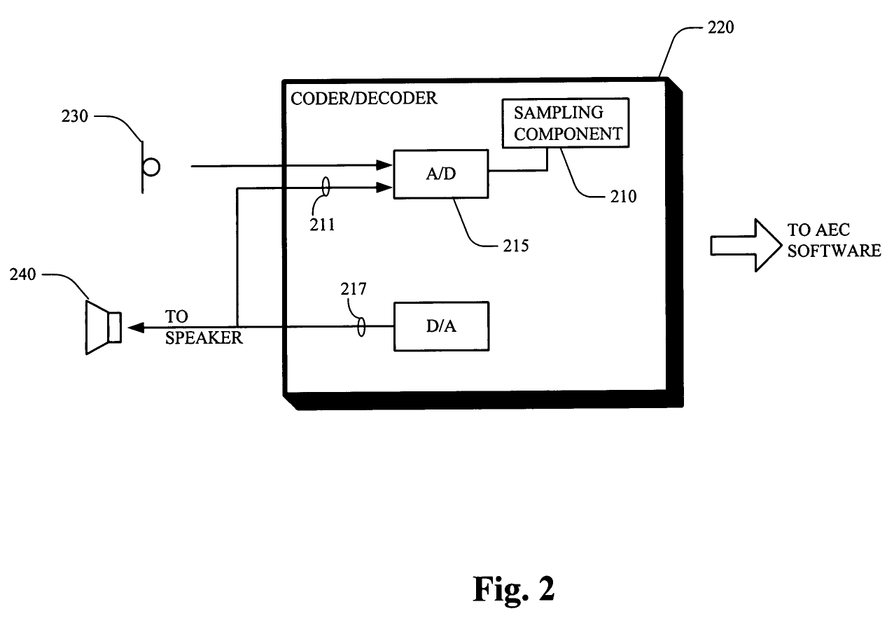

FIG. 2 illustrates a sampling component 210 as part of a coder/decoder processing system (CODEC) 220, according to an aspect of the subject invention. Such CODEC 220 converts digital signals to analog signals and vice versa, wherein the sampling component 210 can supply time synchronized signals of the input audio stream from a microphone 230 and an output audio stream from the speaker 240. The CODEC 220 can include a two channel Analog to Digital (A/D) converter 215, wherein one channel 211 provides connection to an output 217 of the Digital to Analog (D/A) converter associated with the speaker 240. Accordingly, the time relationship between the input audio stream and the output audio stream can be readily identified to the software acoustic echo cancellation for an efficient removal of the far end speaker signal.

The time synchronized samples can be buffered, and supplied to a software acoustic echo canceller (AEC) for production of a reconditioned microphone signal, wherein the speaker signal is absent therefrom. Accordingly, the time synchronized signals can be processed by the software AEC, in general without real time constraints that can be imposed by the operating system (OS). For example, from an OS point of view, high resolution timing constraints can be removed, and adjustments to samples due to time and manner of calling can be mitigated.

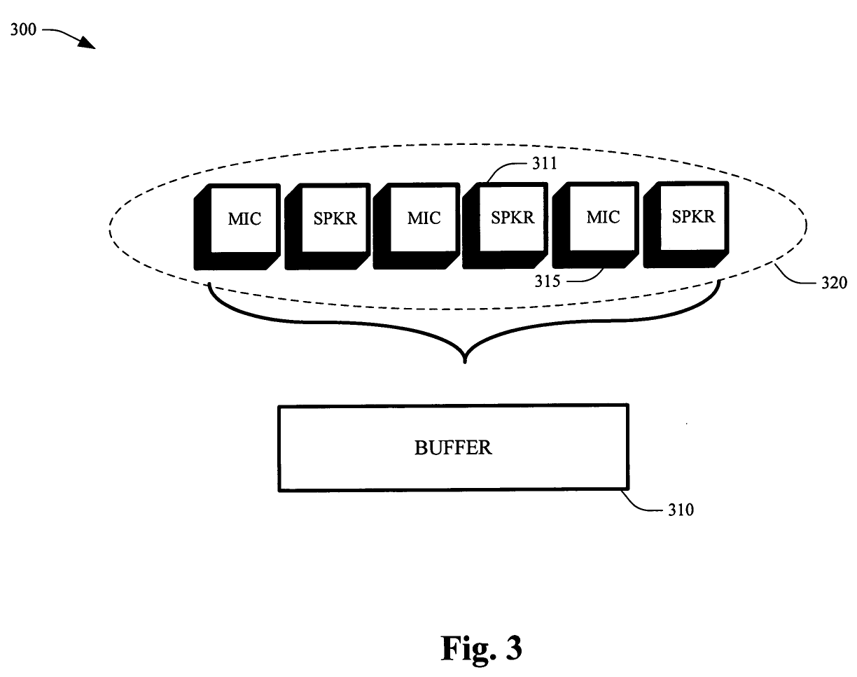

FIG. 3 illustrates an exemplary synchronized signal in accordance to an aspect of the subject invention. Such synchronized signal 300 can then be conveyed to a buffer 310 to be processed by software AEC. The data frame 320 represents a microphone sample 315 and a speaker sample 311 at an instance in time, which are set of time synchronized samples. A sample of the speaker and microphone data can be obtained at a fixed sample rate (e.g., 8 KHz, or 16 KHz, or the like for full duplex communication). Such sample rate remains fixed for every session, even though it can vary from one session to another session. Subsequently, such time synchronized samples can be buffered, and processed by echo cancellation systems and software at a convenient time.

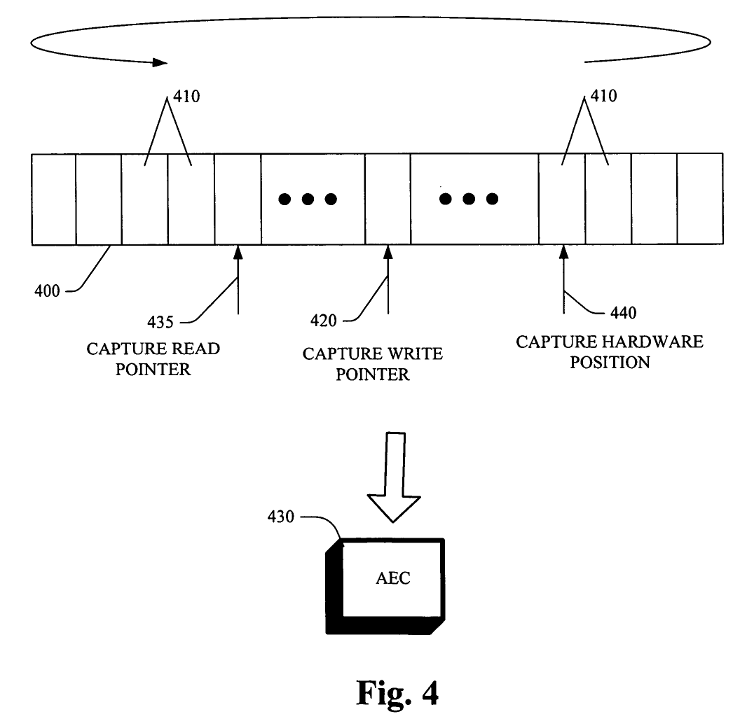

FIG. 4 illustrates a buffer that captures synchronized data in accordance with an exemplary aspect of the subject invention. The capture buffer 400 can be a circular buffer comprising a plurality of storage units 410. Information can be stored in the capture buffer 400 after it is received from the capture sampling component of the subject invention in a sequential fashion from lowest storage unit to the highest storage unit. As capture information is stored into the capture buffer 400, an associated capture write pointer 420 can be increased (e.g., incremented).

Moreover, the capture write pointer 420 can identify the location for the next unit of capture information to be stored (e.g., capture write pointer 420 increased after storing capture information). Alternatively, the capture write pointer 420 can identify the location of the most recent unit of capture information stored (e.g., write pointer increased prior to storing capture information).

Accordingly, once the storage unit in the highest location of the capture buffer 400 is loaded with capture information, capture information is stored in the lowest location and thereafter again proceeds in a direction from the lowest location towards the highest location. Thus, the capture buffer 400 can be employed as a circular buffer for holding samples received from the sampling component. The capture buffer 400 can hold the samples until there are a sufficient number available for the software AEC component 430 to process. Additionally, such capture buffer 400 can be implemented so that the software AEC component 430 can process a linear block of samples without having to know the boundaries of the circular buffer. For example, such can be done by having an extra block of memory that follows and is contiguous with the circular buffer. Whenever data is copied into the beginning of the circular buffer, it can also be copied into such extra space that follows the circular buffer.

The amount of extra space can be determined by the software AEC component 430. The software AEC component 430 can process a predetermined number of blocks of samples, per each session. The size of the extra block of memory can be equal to the number of samples contained in these blocks of samples that are processed by the software AEC component 430. The software AEC component 430 can process a linear block of samples and can be ignorant of the fact that the capture buffer 400 is circular in nature. For example, the data required by the software AEC component 430 that is at the start of the circular buffer, can also be available after the end of the circular buffer in a linear contiguous fashion.

As explained earlier, when the capture information in the capture buffer 400 is processed by the software AEC component 430, then the capture read pointer 430 is increased (e.g., incremented). The capture read pointer 435 can identify the location for the next unit of capture information to be processed (e.g., capture read pointer 435 increased after processing of capture information). Furthermore, the capture read pointer can be increased by the size of one block of capture samples (e.g., Frame Size). In another implementation, the capture read pointer 435 identifies the location of the last unit of capture information removed (e.g., capture read pointer 435 increased prior to removal of capture information).

Generally, the storage units 410 between the capture read pointer 435 and the capture write pointer 420 can comprise valid capture information. In other words, when the capture read pointer 435 is less than the capture write pointer 420, then storage units with a location that is greater than or equal to the capture read pointer 435, and less than the capture write pointer 420 contain valid unprocessed capture samples. The capture write pointer 420 typically leads the capture read pointer 435, except when the capture write pointer 420 has wrapped from the end of the circular buffer to the beginning, and the capture read pointer 435 has not yet wrapped. When the capture read pointer 435 and the capture write pointer 420 are equal, the capture buffer is considered empty.

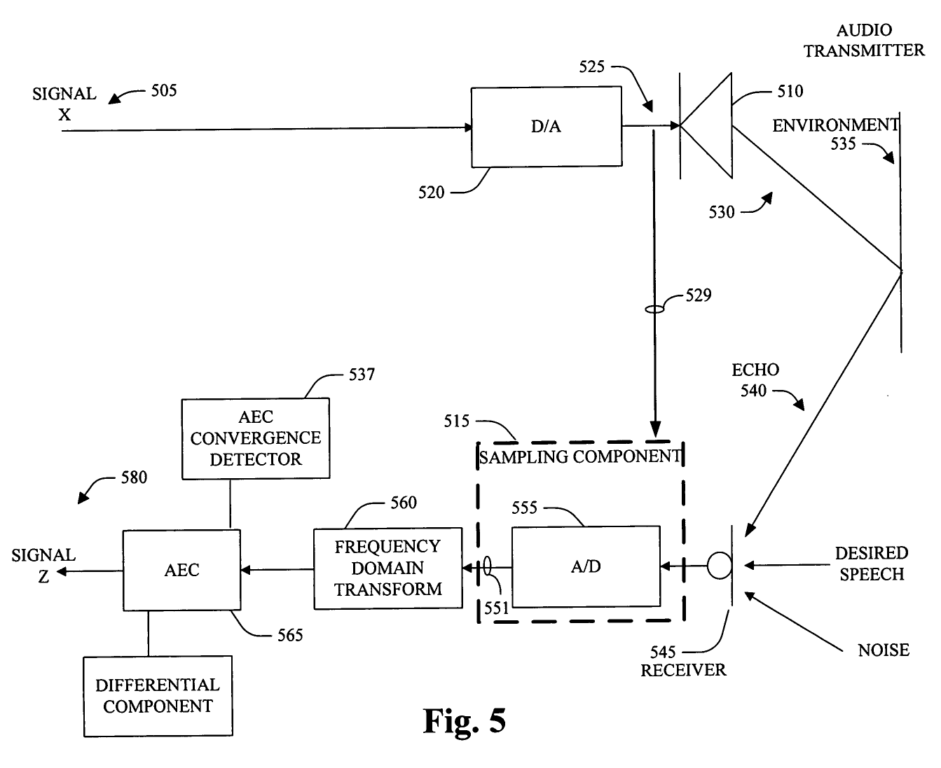

FIG. 5 illustrates a particular schematic block diagram of a software AEC system in accordance with an aspect of the subject invention, which employs a sampling component 515. Such sampling component 515 can take an audio analog signal and a microphone input at a same exact time and at a same clock frequency. In doing so, at the time that the microphone input is being sampled, and concurrently therewith the audio signal is also being sampled. The render device(s) 510 have digital to analog converter(s) (D/As) 520 that convert digital audio sample values into analog electrical waveform(s) at a rate set by a clock signal. The analog waveform drives render transducer(s) 510 which convert the electrical waveform into a sound pressure level. Similarly, a capture transducer converts a sound pressure level into an analog electrical waveform. The capture device 545 has an analog to digital converter (A/D) that converts this analog electrical waveform from the capture transducer 545 into digital audio sample values at a rate set by a clock signal.

As illustrated, the audio analog signal that is also being played by a transmitter 510 (e.g., a loudspeaker) is conveyed from a digital-to-analog (D/A) converter 520. The resulting analog signal at 525 is provided to the transceiver 510, wherein the signal is converted (e.g., via a transducer) to an audio signal of 530. The audio signal can be heard by listeners, absorbed by surrounding structures, and/or reflected by environment 535 (e.g., walls). Such reflections can render an echo of 540 that can be received by a receiver 545 (e.g., a microphone) concurrently receiving a desired signal and/or noise. The received signals are converted to a digital signal with a sampling rate of via an analog-to-digital (A/D) converter 555 as part of a sampling component 515. The sampling component 515 can be connected to an output of the Digital to Analog (D/A) converter 520 associated with the speaker 510 via channel 529. As such, the synchronized signal 551 can then be conveyed to a buffer and/or a frequency domain transform 560, wherein the synchronized signal can be transformed from a time domain to the frequency domain, for example. The data frame represents a microphone sample and a speaker sample at an instance in time, which are paired together and synchronized.

Such synchronized signal can then be conveyed to the software AEC System 565. The audio signal X can be transformed from the time domain to the frequency domain via a frequency domain transform. The software AEC algorithm can run a frequency domain transform (e.g., a Fourier transform (FFT), a windowed FFT, or a modulated complex lapped transform (MCLT)). The software AEC algorithm can then operate on the frequency-domain signals to generate an essentially echo free frequency-domain signal Z of 580. Examples of applications that can benefit from this novel approach include real-time applications, voice over internet protocol, speech recognition and Internet gaming.

Moreover, software AEC convergence detector 537 can alert application(s) when the AEC algorithm has failed to converge and/or lost convergence after previously having converged. Without AEC, captured audio input can include an echo from any sound that is played from the speaker(s). The software AEC algorithm can be used by application(s), such as video conferencing system(s), voice over internet protocol devices and/or speech recognition engine(s) to reduce the echo due to acoustic feedback from a speaker (not shown) to a microphone (not shown). For example, the software AEC algorithm can use an adaptive filter to model the impulse response of the room. The echo is either removed (cancelled) or reduced once the adaptive filter converges by subtracting the output of the adaptive filter from the audio input signal (e.g., by a differential component (not shown)). Failed or lost convergence of the adaptive filter may result in the perception of echo or audible distortion by the end user. The software AEC convergence detector 537 allows application(s) to monitor the quality of the output of the AEC algorithm and provide such information (e.g., to an end user) or automatically change the algorithm in order to improve the quality of the audio experience (e.g., without the need for a headset). Accordingly, the application(s) can alert the end user of the problem and offer suggestion(s) to minimize the problem (e.g., using new hardware or by changing the algorithm).

Due to external condition(s), on occasion the AEC algorithm either cannot converge initially or loses convergence after it has previously converged. Examples of problems that prevent or lead to lost convergence include a problem with the hardware, driver and/or a temporary change in the acoustic path caused by something in the near environment moving. This loss of convergence can lead to perceived echo or noticeable audio distortion to the end user. In order to provide a higher quality listening experience, it is desirable for application(s) that utilize AEC to be able to alert the end user that a quality problem has been detected and/or offer help to fix the problem.

The subject invention (e.g., in connection with mitigating and/or eliminating echoes) can employ various artificial intelligence based schemes for carrying out various aspects thereof. For example, a process for learning explicitly or implicitly when signals in a duplex audio system requires or should be reconditioned can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

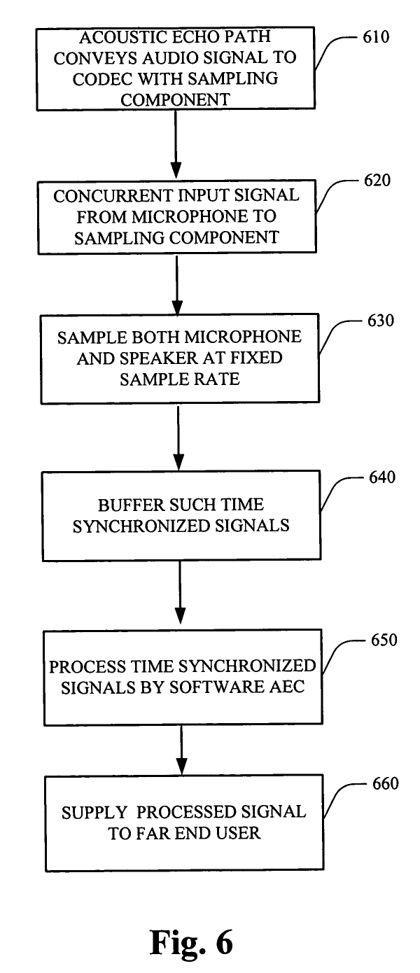

FIG. 6 illustrates an exemplary methodology in accordance with an aspect of the subject invention. While the exemplary method is illustrated and described herein as a series of blocks representative of various events and/or acts, the present invention is not limited by the illustrated ordering of such blocks. For instance, some acts or events may occur in different orders and/or concurrently with other acts or events, apart from the ordering illustrated herein, in accordance with the invention. In addition, not all illustrated blocks, events or acts, may be required to implement a methodology in accordance with the present invention. Moreover, it will be appreciated that the exemplary method and other methods according to the invention can be implemented in association with the method illustrated and described herein, as well as in association with other systems and apparatus not illustrated or described. Initially and at 610, an acoustic echo path can convey an audio signal from an output speaker to a CODEC that includes a sampling component of the subject invention. Concurrently and at 620, an input signal from microphone can be forwarded to such sampling component. Next and at 630, a sampling of the speaker and microphone data can be supplied at a fixed sample rate (e.g., 8 KHz, or 16 KHz, or the like for fill duplex communication). Such sample rate remains fixed for every session, even though it can vary from one session to another session. Subsequently, and at 640 such time synchronized samples can be buffered, and processed by echo cancellation systems and software at 650. Accordingly, the time synchronized samples can be processed by the software AEC, in general without real time constraints that can be imposed by the operating system (OS). For example, from an OS point of view high resolution timing constraints can be removed, and adjustments to samples due to time and manner of calling can be mitigated. The synchronized signal can then be supplied to a far end user at 660.

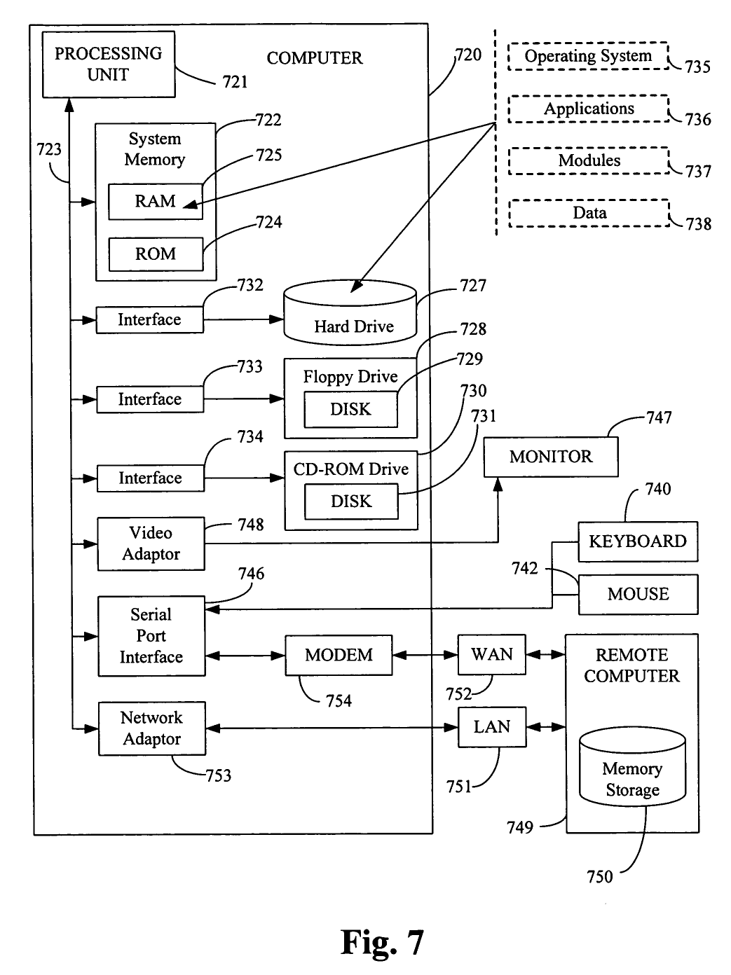

Referring now to FIG. 7, a brief, general description of a suitable computing environment is illustrated wherein the various aspects of the subject invention can be implemented. While the invention has been described above in the general context of computer-executable instructions of a computer program that runs on a computer and/or computers, those skilled in the art will recognize that the invention can also be implemented in combination with other program modules. Generally, program modules include routines, programs, components, data structures, and the like that perform particular tasks and/or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like. As explained earlier, the illustrated aspects of the invention can also be practiced in distributed computing environments where tasks are performed by remote processing devices that are linked through a communications network. However, some, if not all aspects of the invention can be practiced on stand-alone computers. In a distributed computing environment, program modules can be located in both local and remote memory storage devices. The exemplary environment includes a computer 720, including a processing unit 721, a system memory 722, and a system bus 723 that couples various system components including the system memory to the processing unit 721. The processing unit 721 can be any of various commercially available processors. Dual microprocessors and other multi-processor architectures also can be used as the processing unit 721.

The system bus can be any of several types of bus structure including a memory bus or memory controller, a peripheral bus, and a local bus using any of a variety of commercially available bus architectures. The system memory may include read only memory (ROM) 724 and random access memory (RAM) 725. A basic input/output system (BIOS), containing the basic routines that help to transfer information between elements within the computer 720, such as during start-up, is stored in ROM 724.

The computer 720 further includes a hard disk drive 727, a magnetic disk drive 728, e.g., to read from or write to a removable disk 729, and an optical disk drive 730, e.g., for reading from or writing to a CD-ROM disk 731 or to read from or write to other optical media. The hard disk drive 727, magnetic disk drive 728, and optical disk drive 730 are connected to the system bus 723 by a hard disk drive interface 732, a magnetic disk drive interface 733, and an optical drive interface 734, respectively. The drives and their associated computer-readable media provide nonvolatile storage of data, data structures, computer-executable instructions, etc. for the computer 720. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment, and further that any such media may contain computer-executable instructions for performing the methods of the subject invention. A number of program modules can be stored in the drives and RAM 725, including an operating system 735, one or more application programs 736, other program modules 737, and program data 738. The operating system 735 in the illustrated computer can be substantially any commercially available operating system.

A user can enter commands and information into the computer 720 through a keyboard 740 and a pointing device, such as a mouse 742. Other input devices (not shown) can include a microphone, a joystick, a game pad, a satellite dish, a scanner, or the like. These and other input devices are often connected to the processing unit 721 through a serial port interface 746 that is coupled to the system bus, but may be connected by other interfaces, such as a parallel port, a game port or a universal serial bus (USB). A monitor 747 or other type of display device is also connected to the system bus 723 via an interface, such as a video adapter 748, and be employing the various aspects of the invention as described in detail supra. In addition to the monitor, computers typically include other peripheral output devices (not shown), such as speakers and printers. The power of the monitor can be supplied via a fuel cell and/or battery associated therewith.

The computer 720 can operate in a networked environment using logical connections to one or more remote computers, such as a remote computer 749. The remote computer 749 may be a workstation, a server computer, a router, a peer device or other common network node, and typically includes many or all of the elements described relative to the computer 720, although only a memory storage device 750 is illustrated in FIG. 7. The logical connections depicted in FIG. 7 may include a local area network (LAN) 751 and a wide area network (WAN) 752. Such networking environments are commonplace in offices, enterprise-wide computer networks, Intranets and the Internet.

When employed in a LAN networking environment, the computer 720 can be connected to the local network 751 through a network interface or adapter 753. When utilized in a WAN networking environment, the computer 720 generally can include a modem 754, and/or is connected to a communications server on the LAN, and/or has other means for establishing communications over the wide area network 752, such as the Internet. The modem 754, which can be internal or external, can be connected to the system bus 723 via the serial port interface 746. In a networked environment, program modules depicted relative to the computer 720, or portions thereof, can be stored in the remote memory storage device. It will be appreciated that the network connections shown are exemplary and other means of establishing a communications link between the computers can be employed.

In accordance with the practices of persons skilled in the art of computer programming, the subject invention has been described with reference to acts and symbolic representations of operations that are performed by a computer, such as the computer 720, unless otherwise indicated. Such acts and operations are sometimes referred to as being computer-executed. It will be appreciated that the acts and symbolically represented operations include the manipulation by the processing unit 721 of electrical signals representing data bits which causes a resulting transformation or reduction of the electrical signal representation, and the maintenance of data bits at memory locations in the memory system (including the system memory 722, hard drive 727, floppy disks 728, and CD-ROM 731) to thereby reconfigure or otherwise alter the computer system's operation, as well as other processing of signals. The memory locations wherein such data bits are maintained are physical locations that have particular electrical, magnetic, or optical properties corresponding to the data bits.

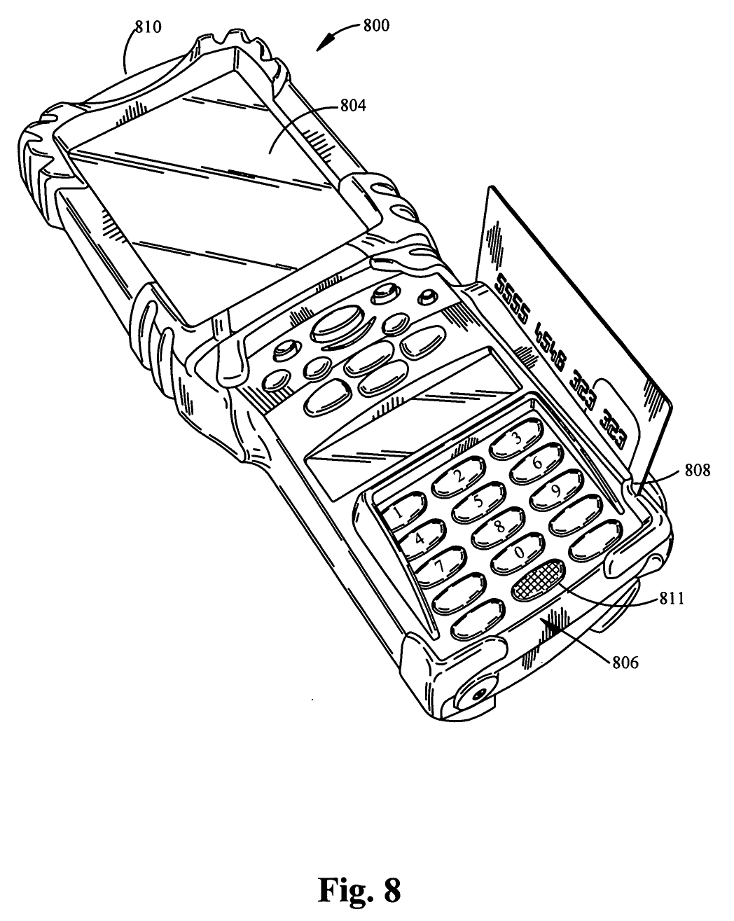

FIG. 8 illustrates an example of a handheld terminal 800 operative to execute the systems and/or methods disclosed herein. The handheld terminal 800 includes a housing 802 which can be constructed from a high strength plastic, metal, or any other suitable material. The handheld terminal 800 includes a display 804. As is conventional, the display 804 functions to display data or other information relating to ordinary operation of the handheld terminal 800 and/or mobile companion (not shown). For example, software operating on the handheld terminal 800 and/or mobile companion can provide for the display of various information requested by the user. Additionally, the display 804 can display a variety of functions that are executable by the handheld terminal 800 and/or one or more mobile companions. The display 804 provides for graphics based alphanumerical information such as, for example, the price of an item requested by the user. The display 804 also provides for the display of graphics such as icons representative of particular menu items, for example. The display 804 can also be a touch screen, which can employ capacitive, resistive touch, infrared, surface acoustic wave, or grounded acoustic wave technology.

The handheld terminal 800 further includes user input keys 806 for allowing a user to input information and/or operational commands. The user input keys 806 can include a full alphanumeric keypad, function keys, enter keys, and the like. The handheld terminal 800 can also include a magnetic strip reader 808 or other data capture mechanism (not shown), and a microphone 811.

The handheld terminal 800 can also include a window 810 in which a bar code reader/bar coding imager is able to read a bar code label, or the like, presented to the handheld terminal 800. The handheld terminal 800 can include a light emitting diode (LED) (not shown) that is illuminated to reflect whether the bar code has been properly or improperly read. Alternatively, or additionally, a sound can be emitted from a speaker (not shown) to alert the user that the bar code has been successfully imaged and decoded. The handheld terminal 800 also includes an antenna (not shown) for wireless communication with a radio frequency (RF) access point; and an infrared (IR) transceiver (not shown) for communication with an IR access point.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes”, “including”, “has”, “having”, and variants thereof are used in either the detailed description or the claims, these terms are intended to be inclusive in a manner similar to the term “comprising”.

What is claimed is:

1. A software acoustic echo canceller (AEC) system comprising:
a sampling component that synchronizes an input microphone signal and an output speaker signal during a full duplex communication at a same clock frequency and same exact time, to form synchronized signals; and
a software AEC component that processes the synchronized signals for a recondition thereof.

2. The software AEC system of claim 1 further comprising a coder/decoder (CODEC) component that interacts with the sampling component.

3. The software AEC system of claim 2, the CODEC includes an analog to digital (A/D) converter with two channels, one of the two channels provides connection to an output of a digital to analog converter of a speaker.

4. The software AEC system of claim 1 further comprising a buffer system that buffers the synchronized signal for a processing by the software AEC component.

5. The software AEC system of claim 1, a reconditioned signal is without an echo.

6. The software AEC system of claim 1, the synchronized signals include a re-sampling of the speaker output.

7. The software AEC system of claim 1, further comprising an adaptive filter to model an impulse response of environment.

8. The software AEC of claim 7 further comprising a differential component that facilitates convergence of the adaptive filter, by a subtraction of an output thereof from an audio input.

9. The software AEC of claim 1, a software AEC algorithm runs a frequency domain transform and employs at least one of a frequency domain transform, a Fourier Transform, and a modulated complex lapped transform.

10. The software AEC of claim 1 further comprising an artificial intelligence component that facilitates removal of an echo from the synchronized signals.

11. A method that facilitates canceling an echo comprising:
synchronizing a speaker signal and a microphone signal during a full duplex communication at a same clock frequency and same exact time via a sampling component, to form a synchronized signal; and
processing the synchronized signal via a software AEC for a reconditiong thereof.

12. The method of claim 11 further comprising conveying an audio signal from an output speaker to a CODEC associated with the sampling component.

13. The method of claim 12 further comprising concurrently sampling the input signal from a microphone and a speaker to a buffer.

14. The method of claim 13 further comprising sampling the audio signal and the input signal from the microphone at a fixed sample rate.

15. The method of claim 13 further comprising buffering the synchronized signal.

16. The method of claim 15 further comprising varying a sample rate from a session to another.

17. The method of claim 16 further comprising processing the synchronized signal without real time constraints imposed by an operating system associated with a system for echo canceling.

18. The method of claim 17 further comprising removing high resolution timing constraints of the operating system during an echo cancellation process.

19. The method of claim 17 further comprising alerting applications when an AEC algorithm fails to converge.

20. A software acoustic echo canceller (AEC) system comprising:
means for synchronizing signals during a full duplex communication at a same clock frequency and same exact time, to form synchronized signals; and
means for processing the synchronized signals for a removal of echo therefrom.
